(19) United States
(12) Patent Application Publication
(10) Pub. No.: US 2014/0308084 A1
(43) Pub. Date: Oct. 16, 2014

(54) DOOR HARDWARE OPENING ENLARGEMENT TOOL

(71) Applicant: Stephen JAMES, Bundoora (AU)

(72) Inventor: Stephen JAMES, Bundoora (AU)

(21) Appl. No.: 14/247,268

(22) Filed: Apr. 8, 2014

(30) Foreign Application Priority Data
Apr. 13, 2013 (AU) 2013901282

(51) Int. Cl. B23B 51/00; B23B 51/04

(52) U.S. Cl. CPC B23B 51/0054; B23B 51/0018; B23B 51/0426; B23B 2247/06; B23B 2251/428; B23B 2251/46; B23B 2270/34
USPC 408/1 R; 408/82

(57) ABSTRACT

The present invention provides an apparatus for facilitating enlargement of a circular opening in a door, the apparatus comprising a spacing means adapted to insert into the circular opening and contact the wall thereof, a guide means adapted to guide a bit portion of a hole saw, wherein the spacing means and guide means are arranged such that in use the guide means is capable of guiding the bit portion of the hole saw along the central longitudinal axis of the circular opening.

### FIELD OF THE INVENTION

The present invention relates to tools, kits and methods useful in the enlargement of openings in doors for the installation of hardware such as door handles and locks.

### BACKGROUND TO THE INVENTION

It is often necessary for a carpenter, locksmith, or even a home handyman to enlarge a circular opening made in a door, generally for the fitting of associated hardware. Typically, the aim is to enlarge an existing opening made to accommodate an older style door fitting (typically of relatively small dimensions), to an opening capable of accepting a larger modern door fitting. In other situations, an opening of an incorrect size has been cut, and an enlargement of the opening required.

Prior art methods for enlarging such openings generally involve the use of a hole saw attached to a drill. The cutting edge of the hole saw is disposed on the door surface about the existing opening, and the drill actuated to rotate the hole saw thereby forming an enlarged hole.

A problem lies in ensuring that the central axis of the new opening aligns with the central axis of the existing opening. Misalignment of the central axis of the enlarged opening leads to problems in fitting the new door hardware.

Apart from the problem of misalignment, application of a hole saw directly over the existing opening typically leads to damage of the face of the door. At first instance, rotation of the saw often causes skipping of the cutting edge across the door face, thereby damaging the door.

In attempts to overcome the problem of misalignment and damage, the prior art provides a number of jig systems adapted to fit over an edge of the door thereby acting as a guide for a hole saw. Such systems are complex, expensive, and do not stand up to multiple uses. Furthermore, accuracy is a problem given that the jig must be carefully and correctly positioned with regard to the position of the existing opening. An example of a prior art contrivance is the Metal and Wood Door Lock Installation Kit supplied by Irwin Tools (a United States company). A further example of this common jig approach is the Door Lock Installation Kit of DeWalt (a United States Company).

It is an aspect of the present invention to overcome or ameliorate a problem of the prior art by providing an apparatus for enlarging a hole in a door, the apparatus providing improved accuracy and/or reduction in damage and/or easy of use and/or economy and/or longevity. It is a further aspect to provide an alternative to apparatus provided by the prior art.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### BRIEF DESCRIPTION OF THE FIGURES

FIG. 1 is a photograph (perspective view) of an apparatus of the present invention, with retaining nut removed.

FIG. 2. Is a photograph (perspective view) of an apparatus of the present invention, with retaining nut fitted.

FIG. 3 is a photograph of an apparatus of the present invention as applied to a circular door opening, the retaining means (the nut) not yet tightened.

FIG. 4 is a photograph of the door after actuation of the hole saw, with enlarged circular opening shown.

FIG. 5 is a photograph of the door after actuation of the hole saw, the apparatus separated from hole saw.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects may apply only to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Unless the contrary intention is expressed, the features presented as preferred or alternative forms of the invention can be present in any of the inventions disclosed as alone or in any combination with each other.

The present invention is predicated at least in part on Applicant's finding that misalignment of an enlarged opening in a door may be overcome by the use of a spacing means adapted to be inserted into an existing opening in a door, and a guide means adapted to receive the bit portion of a hole saw. Accordingly, in one aspect the present invention provides an apparatus for facilitating enlargement of a circular opening in a door, the apparatus comprising a spacing means adapted to insert into the circular opening and contact the wall thereof, a guide means adapted to guide a bit portion of a hole saw, wherein the spacing means and guide means are arranged such that in use the guide means is capable of guiding the bit portion of the hole saw along the central longitudinal axis of the circular opening.

By use of this apparatus, the enlarged opening as formed by the hole saw has a central axis coincident with that of the original opening. This facilitates the fitting of the new door hardware such as handles, latches, knobs, locks and the like. The arrangement of the spacing means with the guide means, and the abutment of the spacing means against the circumferential wall of the circular opening assures that the drill bit portion of the hole saw is maintained on a longitudinal axis that is co-incident with that of the circular opening subject of the enlargement.

A further advantage of the present invention is that the guide means prevents lateral movement of the hole saw when commencing sawing, thereby preventing skipping of the cutting edge across the face of the door.

The present invention is a significant departure from the commonly used prior art jig apparatus described in the Background section herein. Prior art jigs provide a guide for the cutting edge of the hole saw, and the guide and saw are necessarily in close proximity during use. Vibration from the hole saw and abrasion of the saw against parts of the jig causing weakening and eventually breakage. Instead of providing a guide for the hole saw, the present invention guides the bit portion of the hole saw. Given that the bit portion extends beyond the cutting edge of the saw, the hole saw is stabilized within the guide means against lateral movement even before cutting commences. This stabilization limits vibration during cutting thereby minimizing damage to the apparatus. Furthermore, the present apparatus does not rely on the cutting edge of the hole saw being proximal to any guide again limiting the opportunity for damage to the apparatus, this dramatically improving longevity of the apparatus.

The spacing means of the apparatus may be any structure by which the guide means is maintained a set central distance from the circumferential wall of the existing circular opening. It is not essential that the spacing means make contact with the entire circumferential wall. For example, the spacing means may include a spoke arrangement with each spoke contacting only a portion of the circumferential wall, the point at which the spokes meet centrally including the guide means. It will be appreciated that a spoke arrangement may be required at multiple depths into the opening to allow for proper guidance of the bit portion of the drill.

As another alternative, the spacing means is substantially cylindrical, contacting all (or at least most) of the circumferential wall of the existing opening, optionally for the entire depth of the opening.

The guide means may be any structure by which a drill bit portion of a hole saw is directed along a substantially straight line through the existing opening. The guide means may completely surround (and optionally) contact the drill bit portion during cutting, but may in other embodiments contact only portions of the drill portion. The guide means may be substantially continuous, extending from one end of the apparatus to the other, or may be discontinuous and exerting a guiding function only at discrete depths of the apparatus. In one embodiment, the guide means is a continuous channel or a tunnel, and may be a cylindrical tunnel.

As used herein, the term “drill bit portion” is intended to include a standard drill bit of the kind incorporated into commonly available hole saws sold commercially. However, in the context of the present invention the term further includes any member capable of being received by and cooperating with the guide means to ensure no misalignment of the enlarged hole with respect to the existing hole. For example, the drill bit portion may have no ability whatsoever to cut into or remove material from the door, and may simply be an elongate bar having no other features. As will be appreciated, there is no requirement for the drill bit portion of a hole saw to have any drilling function when used in the context of the present invention. Indeed, in some regards it may be desirable that a drill bit portion having no drilling function be used in the context of the present invention given the decreased opportunity for damage to the guide means. Further discussion of this aspect with reference to kits of the present invention is provided infra.

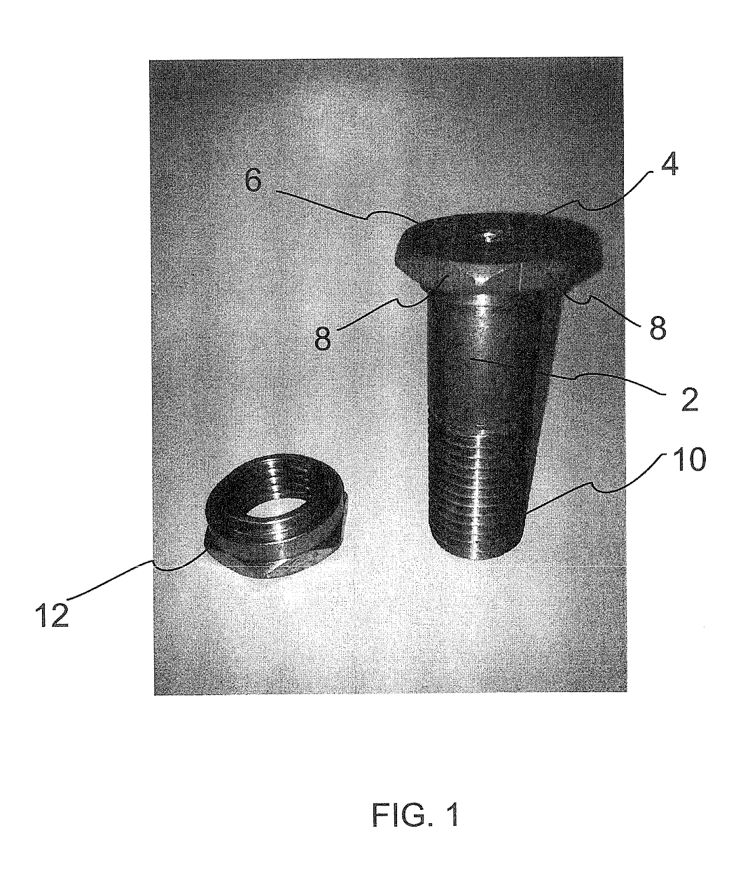

In one embodiment the spacing means is a substantially solid cylinder, with the guide means being an aperture extending along the central axis of the cylinder. Such an embodiment is shown in FIGS. 1 to 5 herein.

The spacing means may be adapted to be inserted into and make contact with the wall of an opening of any diameter. In some embodiments, the spacing means is advantageously adapted for insertion into an opening of a diameter of ⅞ inch or 1 inch. Some embodiments of the apparatus are adapted (by way of varied shaft diameter) to insert snugly into openings of multiple diameters.

The guide means, in some embodiments, may be tapered to allow lodgement in circular openings of a range of circumferences. Thus, the apparatus may be pushed into the opening (and firmly so) so as to be stably and centrally disposed within the opening. In an alternative to tapering, the diameter of the spacing means may be altered along the length in a series of discrete steps.

In some embodiments, the spacing means has a depth which is the same, or substantially the same as the depth of the door under consideration. For example, the spacing means may have a depth selected from about 32 mm to about 50 mm.

The guide means may be adapted to guide a drill bit of any diameter. Typically, the guide means has dimensions allowing the drill bit to rotate substantially freely and to move longitudinally within the guide means to some extent. The skilled artisan will understand however, that excessive free play of the drill bit portion within the guide means will be deleterious to operation of the apparatus, providing for the possibility of a misaligned enlarged opening being formed and also damage to the door face due to skipping.

In one embodiment, the apparatus comprises a stop adapted to prevent the spacing means from pulling out of, or pushing through, the circular opening. The stop is typically disposed at or toward one end of the spacing means, and may comprise a flange adapted to abut the door surface about the circular opening. In one embodiment, the flange is an annular flange that encircles the spacing means completely.

The apparatus may further comprise retaining means adapted to engage with the door thereby preventing rotational and/or lateral and/or longitudinal movement of the apparatus within the circular opening. Firm engagement with the door is advantageous in that the hole saw is better stabilised during cutting. As will be appreciated, a rapidly rotating hole saw can result in considerable vibration and movement of the work area, leading to the potential for skipping and the formation of a misaligned opening.

The retaining means may operate by way of frictional engagement with the wall of the circular opening, a clamping mechanism, or insertion of an anchoring member into the circumferential wall of the circular opening for example. In one embodiment, the apparatus has an external thread, and the retaining means is a nut adapted to engage with the external thread. In this embodiment the nut provides the function of a retaining means by stabilising the apparatus within the circular opening. By screwing the nut further onto the external thread, force is exerted onto the face of the door (by both the stop and the nut) thereby stabilizing the apparatus within the circular opening. Judicious application of force in this way will allow for effective stabilization whilst also avoiding or minimizing damage to the door face. In some embodiments, the nut face and/or stop face abutting the door face is/are fabricated from an elastic and resilient material to limit the possibility of damage to the door.

In one embodiment, the spacing means is a substantially solid cylinder, and the guide means is a circular tunnel extending the length of the cylinder.

In one embodiment the stop and the retaining means are disposed at or toward opposite ends of the spacing means. As an exemplary form of that embodiment, the apparatus is configured substantially as a bolt comprising a central bore. The bolt shaft (the spacing means) is of a diameter allowing for insertion into the circular opening in the door with little or no play. The central bore (the guiding means) is of a diameter allowing for insertion of the drill bit portion of the hole saw with little or no play. The bolt head functions as a stop, preventing the body of the bolt from being pushed or pulled through the circular opening (this undesirable result dependent at least in part on the length of the hole saw). The bolt head is hexagonally shaped to assist in gripping or turning the shaft. The bolt shaft has an external thread upon which a nut may engage, acting as the retaining means.

The apparatus may be fabricated from any one or more suitable materials. All or part of the housing can be fabricated from any suitably rigid material, such as woods, metals, plastics, rubbers or synthetic resins, as are known in the art, by standard techniques for producing durable goods and the like. For example, the apparatus can be fabricated by injection molding or other suitable technique from commercially-available material such as thermo plastic polyurethane (TPU); ionomer resin; ethylene vinyl acetate (EVA); thermo plastic styrenics (TPS); melt processible rubber (MPR); thermo plastic vulcanate (TPV); thermo plastic olefin (TPO); thermo plastic ester elastomer (TPEE); thermo plastic elastomer (TPE); thermoplastic rubber (TPR); polypropylene (PP), polyethylene terephthalate (PET), polyvinyl chloride (PVC); acrylonitrile-butadiene-styrene terpolymer (ABS); a polycarbonate and acrylonitrile-butadiene-styrene copolymer blend (PC/ABS); flexible plastic such as polystyrene sheet or polymethylmethacrylate (PMMA, marketed as “PERSPEX” by ICI Acrylics, Inc.); other acrylics; or any combination thereof.

For improved durability the apparatus is preferentially fabricated from a metal or metal alloy. The skilled person will be familiar with tool fabrication techniques, and select one of more appropriate materials including steel, copper, brass, and aluminium Applicant has found that aluminium is a particularly suitable material, being light and capable of withstanding abrasion caused by the cutting edge and drill bit portion of the hole saw.

In another aspect the present invention provides a kit of parts comprising an apparatus described herein in combination with a hole saw. As used herein, the term “hole saw” in the context of the present kits is intended to include any tool capable of forming an enlarged opening in a door by way of a serrated edged blade, the tool also comprising an elongate member capable of entering into and being guided by the guide means of the apparatus such that an enlarged opening is formed, the enlarged opening having a central longitudinal axis which is substantially co-incident with that of a pre-existing opening. The elongate member may or may not have a drilling function, and in one embodiment functions only to cooperate with the guide means of the apparatus. Optionally, the kit is comprised in packaging to form a vendible product. The kit may include instructions for use of the kit components, the instructions being embodied in any suitable form including text, video, audio, or graphical. The instructions may be printed directly onto any component of the kit, or any associated packaging. Instructions may be presented on a discrete pamphlet, user manual, online presentation system, in electronic form (such as portable document format, text file, or DVD).

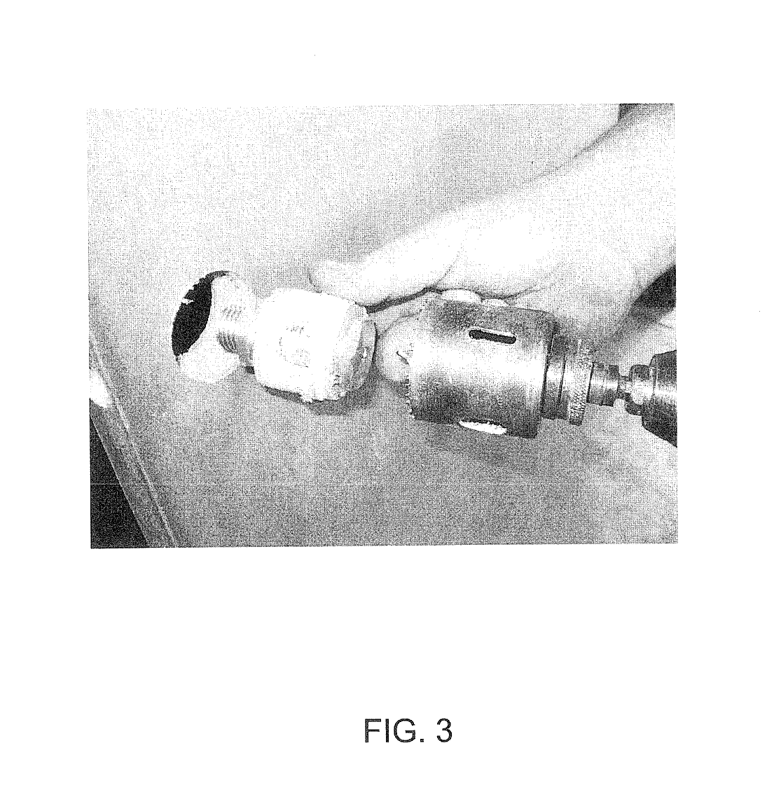

In a further aspect there is provided a method for enlarging a circular opening in a door, the method comprising the steps of providing an apparatus as described herein or a kit as described herein, inserting the apparatus into the circular opening, providing a hole saw, inserting the bit portion of the hole saw into the guide means of the apparatus, and causing the hole saw to rotate thereby forming an enlarged opening. FIG. 3 herein demonstrates assembly of the apparatus onto a door, with insertion of a hole saw into the guide means and abutment of the cutting edge of the saw against the door face.

In one embodiment, the method comprises the step of actuating the retaining means, such as the screwing of a nut onto the spacing means until the apparatus is firmly secured.

The enlarged hole may be cut by cutting from one face of the door to the other in a single action. In some circumstances, it may be necessary to cut from both faces (for example, where the door is thicker than the depth of the hole saw). In that case, the apparatus is advantageously adapted to receive the drill bit portion from both the first and second ends.

It will be understood that while the present invention is particularly applicable to domestic doors, utility may also be found in commercial applications. The invention may be applicable to many types of doors including internal and external doors, cupboard doors, solid doors, cavity doors, wooden doors, metal doors et cetera.

The present invention will now be more fully described by reference to the following non-limiting embodiment.

### PREFERRED EMBODIMENT OF THE INVENTION

Referring first to FIG. 1 there is shown an apparatus of the present invention (fabricated in brass) comprising a solid cylindrical shaft 2 having a central bore 4. The central bore 4 extends downward through the shaft 2 in a straight line exiting at the lower face of the shaft 2 (not shown). A first end of the shaft 2 has an annular flange 6 having six edges (two of which are indicated 8 in this Fig.). A second end of the shaft has an external threaded region 10 adapted to engage a retaining nut 12 (shown disengaged in this Fig.).

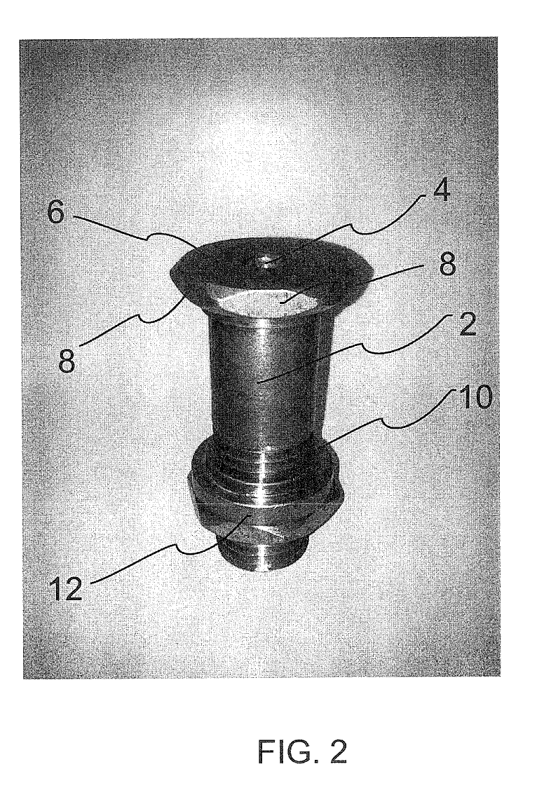

Referring now to FIG. 2 there is shown the apparatus of FIG. 1 with the retaining nut 12 engaged with the threaded portion of the shaft 10.

In use, the shaft 10 (without retaining nut 12) is inserted into the circular opening of the door which is to be enlarged, until the stop 6 abuts the first door face. At this point, a part of the threaded portion 12 extends outwardly from the circular opening of the door at the second door face. The retaining nut 12 is then screwed onto the threaded portion of the shaft 10 until the retaining nut abuts the second door face, and optionally the retaining nut 12 is tightened to more fully engage the door between the stop 6 and retaining nut 12.

Referring now to FIG. 3 there is shown the apparatus 14 of FIGS. 1 and 2 as applied to a door 16, and with a hole saw 18 in position to commence cutting the enlarged opening.

FIGS. 3, 4 and 5 show the operation of an apparatus identical to that shown in FIGS. 1 and 2 (except fabricated in aluminium).

FIG. 3 shows the apparatus of the present invention inserted into a circular door opening in need of enlargement. The apparatus fits snugly into the opening, with the stop (to the rear, not shown) preventing the shaft from pulling through. The retaining means (the nut) has not yet been tightened. In this embodiment of the method the bit portion of the hole saw is inserted into the shaft end having the retaining means.

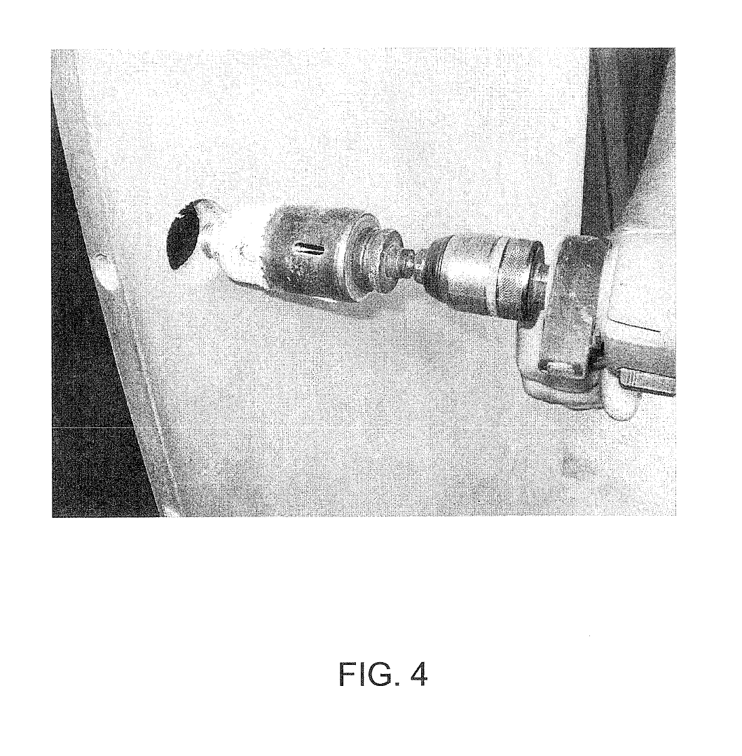

FIG. 4 shows the situation after tightening of the retaining means and actuation of the hole saw. The hole saw (including the apparatus and the plug of wood removed from the door) has been withdrawn from the door, to show the resultant enlarged circular opening. In this embodiment of the method, the drill bit portion of the hole saw is inserted into the end of the apparatus having the stop.

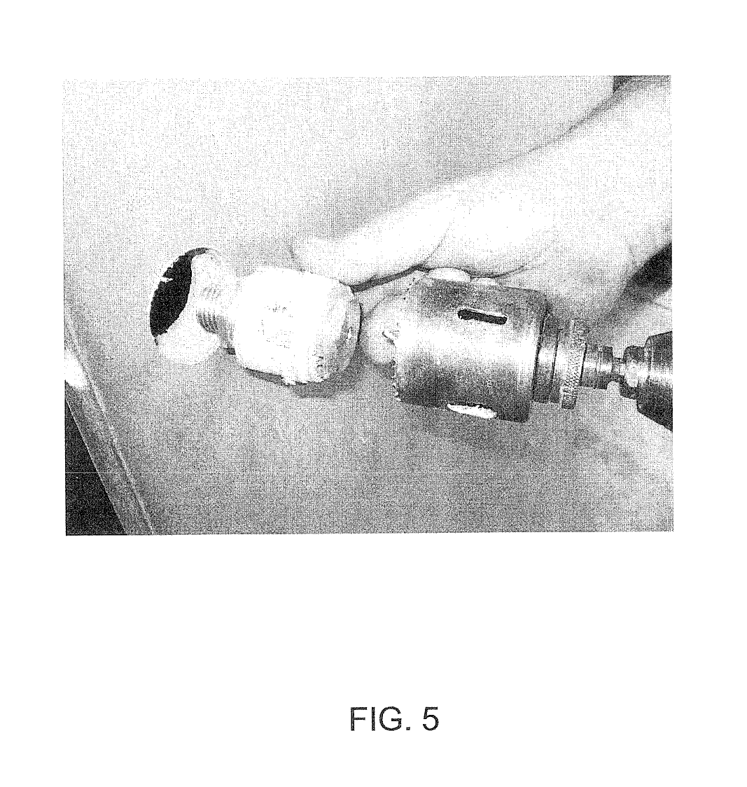

FIG. 5 shows the situation following that shown in FIG. 5, after separation of the plug of wood (still containing the apparatus) from hole saw. It will be noted that the retaining means has been screwed in fully to firmly retain the apparatus against the surrounding wood material.

The invention may be said broadly to consist in the parts, elements and features referred to or indicated in the specification of the application, individually or collectively, in any or all combinations of two or more of said parts, elements or features. Wherein the foregoing description reference has been made to integers or components having known equivalents thereof, those integers are herein incorporated as if individually set forth.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art.

1. An apparatus for facilitating enlargement of a circular opening in a door, the apparatus comprising a spacing means adapted to insert into the circular opening and contact the wall thereof, a guide means adapted to guide a bit portion of a hole saw, wherein the spacing means and guide means are arranged such that in use the guide means is capable of guiding the bit portion of the hole saw along the central longitudinal axis of the circular opening.

2. The apparatus of claim 1 wherein the spacing means is a cylinder having a circumference substantially that of the circular opening.

3. The apparatus of claim 1 wherein the guide means is a channel or tunnel.

4. The apparatus of claim 1 wherein the guide means is a substantially cylindrical tunnel.

5. The apparatus of claim 1 wherein the spacing means comprises a stop adapted to prevent the cylinder pulling out of, or pushing through, the circular opening.

6. The apparatus of claim 5 wherein the stop comprises a flange adapted to abut the door surface about the circular opening.

7. The apparatus of claim 6 wherein the flange is an annular flange.

8. The apparatus of claim 1 comprising retaining means adapted to engage with the door prevent rotational and/or lateral, and/or longitudinal movement of the apparatus within the circular opening.

9. The apparatus of claim 8 wherein the spacing means has an external thread, and the retaining means is a nut adapted to engage with the external thread.

10. The apparatus of claim 8 wherein the stop and the retaining means are disposed at or toward opposite ends of the spacing means.

11. The apparatus of claim 1 wherein the spacing means is a substantially solid cylinder, and the guide means is a circular tunnel extending the length of the cylinder.

12. The apparatus of claim 1 fabricated substantially from a metal.

13. The apparatus of claim 12 wherein the metal is aluminium.

14. A kit of parts comprising an apparatus according to claim 1 in combination with a hole saw.

15. A method for enlarging a circular opening in a door, the method comprising the steps of providing the apparatus of claim 1, inserting the apparatus into the circular opening, providing a hole saw, inserting the bit portion of the hole saw into the guide means of the apparatus, and causing the hole saw to rotate thereby forming an enlarged opening.
